(19) United States
(12) Patent Application Publication
(10) Pub. No.: US 2012/0319017 A1
(43) Pub. Date: Dec. 20, 2012

(54) CONTROL DEVICE FOR VALVE AND VALVE EQUIPPED WITH SUCH CONTROL DEVICE

(75) Inventors: Ludovic Bunod, Bavilliers (FR); Guy Schermesser, Feldkirch (FR)

(73) Assignee: GENERAL ELECTRIC COMPANY, Schenectady, NY (US)

(21) Appl. No.: 13/467,939

(22) Filed: May 9, 2012

(30) Foreign Application Priority Data
Jun. 15, 2011 (FR) 1155196

(51) Int. Cl. F16K 35/00

(52) U.S. Cl. 251/89

(57) ABSTRACT

This control device for a valve comprises a head (5) designed to fit onto a corresponding control rod (T) of the valve and a handle (3) that can be operated manually by a user to angularly move the head and control rod between a first angular closed position of the valve and a second angular open position of the valve. The head comprises locking apparatuses (9, 10) designed to cooperate with complementary locking apparatuses (13) provided on a raised extension (11) the valve and capable of preventing the release of the handle (3) and of the head (5) from the first angular closed position of the valve.

### CROSS-REFERENCE TO RELATED APPLICATION

This application claims priority to and the benefit of French Patent Application No. 1155196, entitled “Control device for valve and valve equipped with such a control device”, filed Jun. 15, 2011, which is herein incorporated by reference in its entirety.

### BACKGROUND OF THE INVENTION

In general, the invention relates to the field of valves intended for electricity production facilities. More particularly, the invention relates to the control of such valves.

As we know, thermal powerplants that produce electricity comprise, in particular, a turbine powered by fuel, such as fuel oil, and can comprise several combustion chambers. The performance of a powerplant can deteriorate over time for various reasons. In the first place, the aging of the facility can result in deterioration of powerplant performance. Corrosion can also influence thermal powerplant performance. Finally, the fouling of the compressor and, in particular, the stages of the turbine can have a relatively significant impact on performance of the powerplant. The fouling of the compressor is particularly liable to cause a reduction in the usable cross-section of the turbine and a deterioration of its aerodynamic characteristics.

The type of fuel oil used has a relatively significant impact on the fouling of the turbine, particularly of its first stages. During combustion of heavy fuel oil, this fouling phenomenon is exacerbated so that the turbine stages must be cleaned on a regular basis. Cleaning can be carried out when the machine is shut down by injecting water combined with a detergent onto the surfaces of the turbine stages. Another method is to perform the cleaning when the machine is in operation by injecting an abrasive product into the combustion chambers that is then carried by the hot gases through the turbine stages. A product is chosen that will be destroyed by combustion, releasing nothing but smoke that is evacuated by the exhaust gases of the turbine. The injection consists of using pressurized air, for example at 26 bars, and at a temperature of about 200° C., extracted as it is discharged from the turbine compressor.

Cleaning performed during operation of the machine is generally termed “on-line” cleaning. A specific module is used to load the abrasive product into a tank, place the tank under pressure and convey the product to the different combustion chambers. Conveying of the product must be done sequentially in order to avoid disturbing the combustion and ensure that the chambers are fed an identical quantity of product.

### BRIEF DESCRIPTION OF THE INVENTION

In order to inject the product into the combustion chambers, a set of valves, placed between the product tank and the combustion chambers, is controlled sequentially. The valves are opened and closed one after the other in such a way that it is not possible for two valves to be open simultaneously. Consequently, the operation of opening and closing the valves to convey the product requires numerous successive manual operations. Such operations can result in handling errors.

In view of the foregoing, the purpose of the invention is to propose a valve control device that makes it possible to prevent any risk of mishandling, and in particular, to prevent the simultaneous opening of a set of valves intended to be controlled sequentially.

An object of the invention is therefore a valve control device comprising a head designed to fit onto a corresponding control rod of the valve and a handle that can be operated manually by a user to move the head and control rod angularly between a first angular closed position of the valve and a second angular open position of the valve. The head has a locking apparatus that is designed to cooperate with complementary locking apparatuses on the valve that can prevent the head and handle from being released from the first angular closed position of the valve.

Another feature of the invention, where the valve is of the quarter-turn type, is that the head comprises at least one radial pin designed to enter a corresponding recess in a flange fitted on a raised extension of the valve when the head is released. For example, the device is equipped with a pair of diametrically opposite radial pins.

In one design, the head has a radial arm with a central recess that matches the control rod, each of the two mutually opposite ends of the arm being equipped with a return forming a crosspiece extended by a radial pin. Usefully, the handle constitutes a wrench for actuating the valve.

Another aspect of the invention is a valve comprising a valve body, a control rod projecting out of the valve body and a control device, which has a head that is designed to fit onto the control rod and a handle that can be manually operated by a user to angularly move the head and control rod between a first angular closed position of the valve and a second angular open position of the valve. The head and the valve body have complementary locking apparatuses that can prevent the release of the head and the handle out of the first angular closed position of the valve.

Other purposes, features and advantages of the invention are set out in the following description, which is provided solely as an example, with reference to the appended drawings in which:

### BRIEF DESCRIPTION OF THE DRAWINGS

FIG. 1 is a perspective view of a valve fitted with a control device according to the invention, in which the head and the handle are ready to fit onto a raised extension of the valve and in which the valve is in the closed position;

FIG. 2 shows the valve of FIG. 1 with the head and the handle fitted onto the control rod and with the valve in the closed position; and

FIG. 3 shows the valve of FIG. 1 in the locked position of the control device and the open position of the valve.

### DETAILED DESCRIPTION OF THE INVENTION

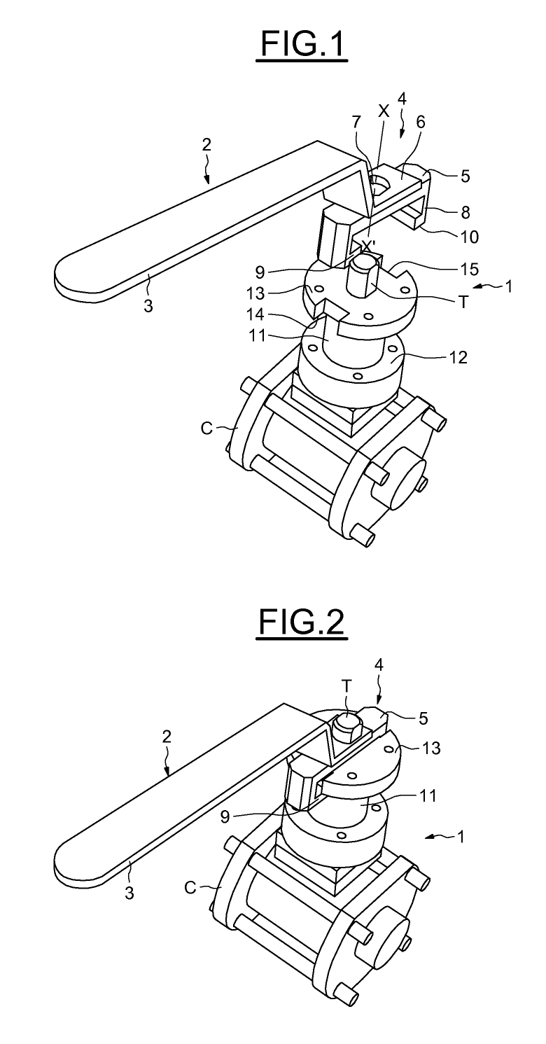

With reference to FIG. 1, the general structure of a valve according to the invention provided with a control device will now be described.

In the design described, the valve, designated by the general numerical reference 1, is part of a set of valves laid out in parallel, each intended to convey into a combustion chamber of a turbine a product, particularly abrasive, capable of performing a so-called “on-line” cleaning, i.e. cleaning during operation of the turbine.

It should be noted that the nature of the product used to perform this on-line cleaning is well known. However, the valves, such as 1, each of which connects a product tank to a combustion chamber of the turbine, must be controlled sequentially, i.e. one after the other. In other words, the opening of one of the valves should only be possible if all of the other valves are closed in order to ensure the safety of operators during the cleaning phase, and in particular, to prevent risks of burns due to the temperature levels of the product used.

In order to guarantee their sequential operation, each valve 1 is fitted with a removable control device 2. A single control device is provided for all of the valves in such a way that when one of the valves is actuated, the others remain in their initial closed position.

As can be seen in FIG. 1, the control device 2 essentially comprises a handle 3, which can be operated manually by a user, shown here in the shape of a rectilinear rod. One end 4 of the handle 3 has a stepped shape and is provided with a head 5 for actuating the valve. The assembly is made of metal in this example.

In the design illustrated in FIG. 1, the actuating head 5 essentially comprises a radial arm 6 provided with a central orifice 7, the axis X-X′ of which defines an axis of rotation for the control device 2. The mutually opposite ends of the radial arm are equipped with a return, such as 8, extending at a right angle from the arm 6 and forming a crosspiece. Finally, the actuating head 5 is equipped with two radial pins 9 and 10 facing each other and extending parallel to the radial arm 6.

The valve 1 is a conventional quarter-turn type valve. Its structure will therefore not be described in detail below. However, it should be noted that the valve 1 is equipped with a control rod T that projects out of the valve body C. Furthermore, it should be noted that the valve body C is equipped with an essentially cylindrical raised extension 11 surrounding the control rod T and comprising an end-plate 12 by which it is attached to the valve body C, for example by screws, and an opposite flange 13 comprising a means of locking the control device on the raised extension 11.

As is shown, the flange 13 is equipped with two diametrically opposite recesses 14 and 15 with shapes that are complementary to those of the pins 9 and 10, and it is shaped to allow the insertion of the actuating head 5 into the control rod and its release in a unique angular position of the actuating head. The recesses are thus made in the flange in the general direction adopted by the actuating head in the closed position of the valve.

The height of the crosspiece formed by the returns 8 of the head is substantially greater than that of the crosspiece so that when the head 5 is engaged on the control rod, the pins are located below the lower face of the flange. For example, the control rod T is equipped with two longitudinal flat faces so that the axial orifice 7 adopts a complementary shape comprising two mutually opposite sides that are rectilinear and parallel.

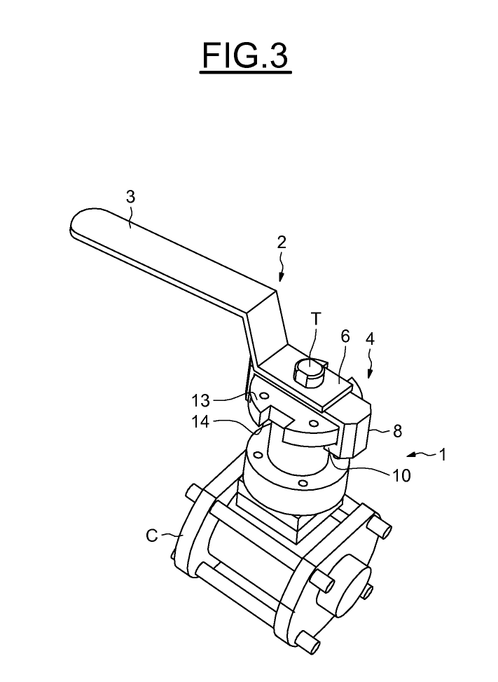

Starting from the closed position illustrated in FIG. 1, the actuating of the valve 1 is accomplished by orienting the control device 2 so as to position the pins of ends 9 and 10 facing the recesses 14 and 15, and by moving the control rod T into the orifice of the radial arm 6 (FIG. 2). When the handle 3 is moved angularly until the valve is opened, the pins 9 and 10 remain pressed against the full part of the flange 13 and lock the control device onto the valve body C and in particular onto the locking apparatus 13 of the raised extension. Thus, it is only when the control device is repositioned to the closed position of the valve that it can be released from the valve body in order to be used to actuate another valve (FIG. 3).

The sequential control procedure of a set of valve[s] therefore consists first in actuating a first valve by positioning the control device in such a way as to orient the radial pins 9 and 10 to face the recesses 14 and 15, to move the actuating head onto the control rod of the valve, to open the valve to feed on-line cleaning product to the combustion chamber, to reclose the valve, and to release the control device. The control device can then be used in the same way to successively actuate the other valves.

It can therefore be seen that, through the use of the locking apparatuses on the control device as well as on the valve, which allow the release of the control device only when the valve is in the closed position, it is guaranteed that when only one control device is used, it is not possible for multiple valves to be open simultaneously. Moreover, it should be noted that this objective is achieved by using a control device with a particularly simple structure, very compact and very inexpensive.

It should further be noted that the use of any other means to operate the valve is prevented, for example an adjustable wrench, as a result of the raised extension that surrounds a substantial part of the control rod. Finally, the axial orifice 7 of the handle and/or the end pins 9 and 10 conform to the control rod T and/or the recesses 14 and 15. In other words, the handle and the valve as well as the raised extension will be advantageously configured in such a way that the handle is dedicated to the predetermined control of valves and acts as wrench and that each valve of this set of valves can only be actuated by the handle associated with it.

1. Control device for valve comprising a head intended to move onto a corresponding control rod of the valve and a handle that can be operated manually by a user to angularly move the head and control rod between a first angular closed position of the valve and a second angular open position of the valve, characterized in that the head comprises locking apparatuses designed to cooperate with complementary locking apparatuses provided on the valve and capable of preventing the release of the handle and of the head from the first angular closed position of the valve.

2. Device according to claim 1, characterized by a valve of the quarter-turn type, the head comprising at least one radial pin intended to enter a corresponding recess made in a flange on a raised extension of the valve when the head is released,

3. Device according to claim 2, characterized by a pair of diametrically opposite radial pins.

4. Device according to claim 3, characterized by a head comprising a radial arm having a central recess that matches the control rod and two mutually opposite ends of the arm, each being equipped with a return forming a crosspiece extended by a radial pin.

5. Device according to claim 4, characterized by a handle that constitutes a wrench for actuating the valve.

6. Valve comprising a valve body, a control rod projecting out of the valve body and a control device, said control device comprising a head intended to fit onto the control rod and a handle that can be manually operated by a user to angularly move the head and control rod between a first angular closed position of the valve and a second angular open position of the valve, characterized by a head and valve body that have complementary locking apparatuses capable of preventing the release of the head and of the handle out of the first angular closed position of the valve.
